(19) United States
(12) Patent Application Publication
(10) Pub. No.: US 2012/0196199 A1
(43) Pub. Date: Aug. 2, 2012

(54) FUEL CELL SYSTEM AND METHOD FOR CONTROLLING THE SAME

(75) Inventors: Chin-Hao Wu, Hsinchu County (TW); Kuo-Tai Hung, Hsinchu County (TW)

(73) Assignee: YOUNG GREEN ENERGY CO., HSINCHU COUNTY (TW)

(21) Appl. No.: 13/353,326

(22) Filed: Jan. 19, 2012

(30) Foreign Application Priority Data
Jan. 30, 2011 (CN) 201110035105.7

(51) Int. Cl. H01M 8/04

(52) U.S. Cl. 429/432; 429/442

(57) ABSTRACT

A fuel cell system and a method for controlling the same are provided. Based on the method, a control temperature of a fuel cell stack is set, and an environment temperature and an operating temperature of the fuel cell stack are detected. A thermal resistance of the fuel cell stack is calculated according to the environment temperature, the operating temperature and a current heating amount. An allowable heating amount of the fuel cell stack is set according to the control temperature, the environment temperature, and the thermal resistance. When the current heating amount is less than the allowable heating amount and the operating temperature is less than the control temperature, the current heating amount is increased, and when the current heating amount is greater than the allowable heating amount or the operating temperature is greater than the control temperature, the current heating amount is decreased.

### CROSS-REFERENCE TO RELATED APPLICATION

This application claims the priority benefit of China application serial no. 201110035105.7, filed on Jan. 30, 2011. The entirety of the above-mentioned patent application is hereby incorporated by reference herein and made a part of this specification.

### BACKGROUND

1. Field of the Invention

The invention relates to a fuel cell system and a method for controlling the same. Particularly, the invention relates to a fuel cell system having a temperature protection mechanism and a method for controlling the same.

2. Description of Related Art

Development and application of energy have always been indispensable conditions of human life; nevertheless the development and application of energy may cause increasing damage to the environment. Energy from a fuel cell technique has advantages of high efficiency, low noise, and pollution-free, etc. which is an energy technology in line with a trend of the times. Types of the fuel cells are diversified, and a commonly used one is a proton exchange membrane fuel cell (PEMFC). Moreover, in the fuel cell system, an operating temperature of a fuel cell stack is one of major performance indexes.

A portable fuel cell is one of novel fuel cell applications in recent years, and during a process of miniaturizing the fuel cell, some non-essential auxiliary devices (for example, a cooling fan) are simplified. In the fuel cell system without the cooling fan, temperature control is more important and difficult.

FIG. 1 is a graphical illustration of current density of a fuel cell stack versus voltage of a fuel cell stack under different operating temperatures. Referring to FIG. 1, it is known that the higher the operating temperature of the fuel cell stack is, the greater the output voltage is under a same current density, and the better the performance is due to that relatively high temperature may help an electrochemical reaction and a transmission speed of protons transmitted in a proton exchange membrane. However, the operating temperature of the fuel cell stack could not be increased without limitation since the excessive high operating temperature may damage the material of the proton exchange membrane, which may cause a great reduction of a service life of the fuel cell.

FIG. 2 is a flowchart illustrating a temperature control method of a fuel cell system. Referring to FIG. 2, a temperature of the fuel cell stack is first obtained (step S210), and it is determined whether the temperature is greater than a protection temperature (step S220). When the temperature of the fuel cell stack is greater than the protection temperature, it represents that excessive heat is generated by the fuel cell, and the output power of the fuel cell is required to be reduced (step S230), so as to reduce the temperature of the fuel cell stack. When the temperature of the fuel cell stack is less than the protection temperature, it represents that the heat generated by the fuel cell is within an allowable range, and the output power of the fuel cell could be increased (step S240). However, such control method only determines whether the temperature of the fuel cell stack is greater than the protection temperature, which may cause unstable temperature of the fuel cell system whose temperature excessively oscillates.

Moreover, Taiwan Patent publication No. 201025790 discloses a power supply apparatus having temperature compensation control, which could selectively supply an external power to a load or charge a cell by the external power. An output voltage of the power supply apparatus has a high limit and a low limit, and when a sensing temperature is lower than a predetermined temperature, the output voltage is allowed to be the high limit, and when the sensing temperature is higher than the predetermined temperature, a highest allowable value of the output voltage is gradually decreased as a temperature difference of the sensing temperature and the predetermined temperature increases, though it is still higher than the low limit. Moreover, Taiwan Patent publication No. 200733465 discloses a control method of a power system. Further, U.S. Patent application No. 2005/0069740 discloses a modulation and temperature control method of a fuel cell system. Moreover, U.S. Pat. No. 6,881,509 discloses a power control method and system for a fuel cell system.

### SUMMARY OF THE INVENTION

The invention is directed to a method for controlling a fuel cell system, by which an allowable heating amount of a fuel cell stack is set according to an environment temperature, a control temperature of the fuel cell stack and a thermal resistance of the fuel cell stack, so as to avoid whose temperature excessively oscillates.

The invention provides a fuel cell system, which could set an allowable heating amount of a fuel cell stack according to an environment temperature, a control temperature of the fuel cell stack and a thermal resistance of the fuel cell stack, so as to control a temperature of the fuel cell stack without a cooling device.

Additional aspects and advantages of the invention will be set forth in the description of the techniques disclosed in the invention.

To achieve one of or all aforementioned and other advantages, an embodiment of the invention provides a method for controlling a fuel cell system, which includes following steps. A control temperature of a fuel cell stack is set, and an environment temperature of the fuel cell system and an operating temperature of the fuel cell stack are detected. A current heating amount of the fuel cell stack is calculated according to an output voltage and an output current of the fuel cell stack. A thermal resistance of the fuel cell stack is calculated according to the environment temperature, the operating temperature and the current heating amount. An allowable heating amount of the fuel cell stack is set according to the control temperature, the environment temperature and the thermal resistance. When the current heating amount is less than the allowable heating amount and the operating temperature is less than the control temperature, the current heating amount is increased, and when the current heating amount is greater than the allowable heating amount or the operating temperature is greater than the control temperature, the current heating amount is decreased.

In one embodiment of the invention provides a fuel cell system including a fuel cell stack, a first temperature sensor, a second temperature sensor, a voltage current detection unit and a processor. The fuel cell stack is used for carrying out a chemical reaction to produce electric energy. The first temperature sensor is used for detecting an operating temperature of the fuel cell stack. The second temperature sensor is used for detecting an environment temperature. The voltage current detection unit is used for detecting an output voltage and an output current of the fuel cell stack. The processor is electrically connected to the first temperature sensor, the second temperature sensor and the voltage current detection unit. The processor calculates a current heating amount according to the output voltage and the output current of the fuel cell stack. The processor calculates a thermal resistance of the fuel cell stack according to the environment temperature, the operating temperature and the current heating amount. The processor sets an allowable heating amount of the fuel cell stack according to a control temperature, the environment temperature and the thermal resistance. The processor adjusts the current heating amount according to the current heating amount, the allowable heating amount, the operating temperature and the control temperature.

In an embodiment of the invention, the fuel cell system further includes a converter. The converter is electrically connected to the fuel cell stack and the processor for converting the output voltage or the output current of the fuel cell stack to generate and output a load voltage.

In an embodiment of the invention, the environment temperature is Tₐ, the operating temperature is Tₛ, the control temperature is T_{c}, the current heating amount is E_{gen}, and the thermal resistance is R, R is equal to

$$\frac{( {T}_{s} - {T}_{a} )}{{E}_{gen}} ,$$

and the allowable heating amount is equal to

$$\frac{( {T}_{c} - {T}_{a} )}{R} .$$

In an embodiment of the invention, when the current heating amount is increased or decreased, the processor adjusts the current heating amount by adjusting the output voltage or the output current.

In an embodiment of the invention, the fuel cell stack is a proton exchange membrane fuel cell (PEMFC) stack.

According to the above description, in at least one of the invention, the processor of the fuel cell system adaptively sets the allowable heating amount of the fuel cell stack according to the difference between the environment temperature and the temperature of the fuel cell stack, so as to control the temperature without using a cooling device, and to avoid whose temperature excessively oscillating.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a current density-voltage curve of a fuel cell stack at different operating temperatures.

FIG. 2 is a flowchart illustrating a temperature control method of a conventional fuel cell system.

FIG. 3 is a block diagram of a fuel cell system according to an embodiment of the invention.

FIG. 4 is a flowchart illustrating a method for controlling a fuel cell system according to an embodiment of the invention.

FIG. 5A is a graphical illustration of operating temperature of a fuel cell stack versus time and a thermal resistance of a fuel cell stack versus time after a fuel cell system is operated according to an embodiment of the invention.

FIG. 5B is a graphical illustration of allowable heating amount of a fuel cell stack versus time and current heating amount of a fuel cell stack versus time after a fuel cell system is operated according to an embodiment of the invention.

FIG. 6 is a graphical illustration of operating temperature versus time, allowable heating amount versus time, and current heating amount versus time, which are obtained through an actual test of a fuel cell system according to an embodiment of the invention.

### DETAILED DESCRIPTION OF DISCLOSED EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

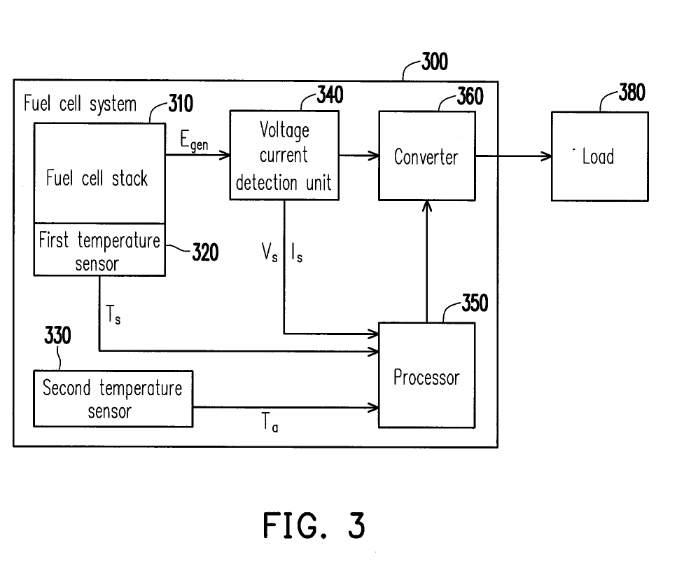

FIG. 3 is a block diagram of a fuel cell system according to an embodiment of the invention. Referring to FIG. 3, the fuel cell system 300 includes a fuel cell stack 310, a first temperature sensor 320, a second temperature sensor 330, a voltage current detection unit 340, a processor 350, and a converter 360. The fuel cell stack 310 is used for carrying out a chemical reaction to output electric energy. In an embodiment of the invention, the fuel cell system 300 is a proton exchange membrane fuel cell (PEMFC). In another embodiment of the invention, the fuel cell system 300 is a direct methanol fuel cell (DMFC). Regardless of the PEMFC or the DMFC, both of them are belonged to a low-temperature start-up fuel cell using a proton exchange membrane for implementing a proton conduction mechanism. An operation principle of the PEMFC is as follows. Hydrogen has an oxidation reaction at an anode catalyst layer to generate hydrogen ions (H⁺) and electrons (e⁻) (PEMFC principle), or methanol and water have an reaction at the anode catalyst layer to generate hydrogen ions (H⁺), carbon dioxide (CO₂), and electrons (e⁻) (DMFC principle), where the hydrogen ions are transmitted to a cathode through the proton exchange membrane, and the electrons are transmitted to a load through an external circuit and then transmitted to the cathode. Afterwards, the oxide supplied to the cathode and the hydrogen ions and the electrons carry out an oxidation-reduction reaction at a cathode catalyst layer to generate water.

The first temperature sensor 320 is used for detecting an operating temperature Tₛ of the fuel cell stack 310. During measurement, the first temperature sensor 320 contacts the fuel cell stack 310 or detecting the fuel cell stack 310 via infrared to obtain a surface temperature of the fuel cell stack 310. The surface temperature is the operating temperature Tₛ of the fuel cell stack 310 of the embodiment. The second temperature sensor 330 is used for detecting an environment temperature Tₐ of the fuel cell system 300. The voltage current detection unit 340 is used for detecting an output voltage Vₛ and an output current Iₛ of the fuel cell stack 310, where the voltage current detection unit 340 could be a device capable of measuring voltages and currents such as a combination of an ohmmeter and an ammeter, or an avometer. The processor 350 is electrically connected to the first temperature sensor 320, the second temperature sensor 330 and the voltage current detection unit 340 for receiving signals measured by the first temperature sensor 320, the second temperature sensor 330 and the voltage current detection unit 340. The processor 350 calculates a current heating amount E_{gen}, E_{gen}∝I_{S}×V_{S} according to the output voltage Vₛ and the output current Iₛ of the fuel cell stack 310 that are detected by the voltage current detection unit 340.

The processor 350 calculates a thermal resistance R of the fuel cell stack 310 according to the operating temperature Tₛ and the environment temperature Tₐ detected by the first temperature sensor 320 and the second temperature sensor 330, and the current heating amount E_{gen}. In an embodiment of the invention, the thermal resistance R is equal to

$$\frac{( {T}_{s} - {T}_{a} )}{{E}_{gen}} .$$

Herein the thermal resistance R is proportional to a reciprocal of the current heating amount E_{gen}, and is inversely proportional to the output voltage Vₛ or the output current Iₛ. However, it should be noticed that the calculation method of the thermal resistor R is not limited thereto.

Moreover, the processor 350 sets an allowable heating amount E_{allow} of the fuel cell stack 310 according to a predetermined control temperature T_{c}, the environment temperature Tₐ, and the thermal resistance R. Herein, a magnitude of the control temperature T_{c} is a default value, which has different values according to different fuel cell systems (fuel cell stacks). In the embodiment, the control temperature T_{c} is a predetermined maximum allowable temperature of the fuel cell stack 310. In detail, in the fuel cell system 300 controlled according to the method of the embodiment of the invention, under a normal circumstance, the operating temperature Tₛ of the fuel cell stack 310 will not exceed the control temperature T_{c} in most of the time. Moreover, in an embodiment of the invention, the allowable heating amount E_{allow} is equal to

$$\frac{( {T}_{c} - {T}_{a} )}{R} .$$

However, it should be noticed that the calculation method of the allowable heating amount E_{allow} is not limited thereto.

The converter 360 is electrically connected to the fuel cell stack 310 and the processor 350 for converting the output voltage or the output current of the fuel cell stack 310 to generate and output a load voltage to a load 380.

In the embodiment, when the current heating amount E_{gen} is less than the allowable heating amount E_{allow} and the operating temperature Tₛ is less than the control temperature T_{c}, the processor 350 increases the current heating amount E_{gen} by controlling an operation of the converter 360. One the other hand, when the current heating amount E_{gen} is greater than the allowable heating amount E_{allow} or the operating temperature Tₛ is greater than the control temperature T_{c}, the processor 350 decreases the current heating amount E_{gen} by controlling the converter 360.

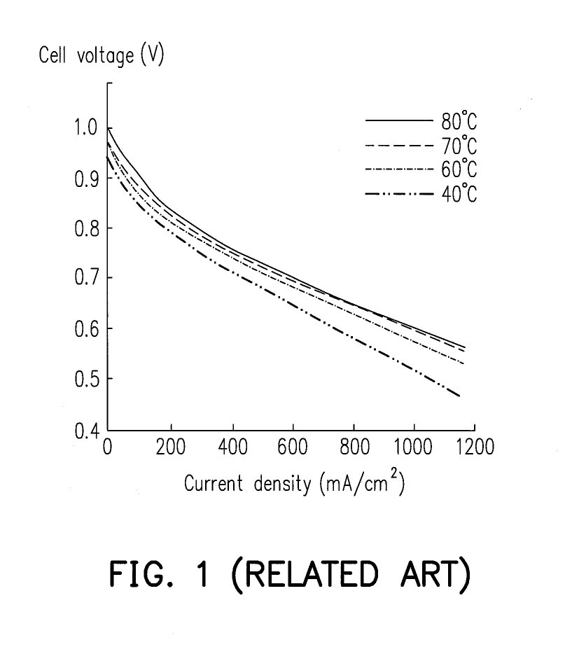

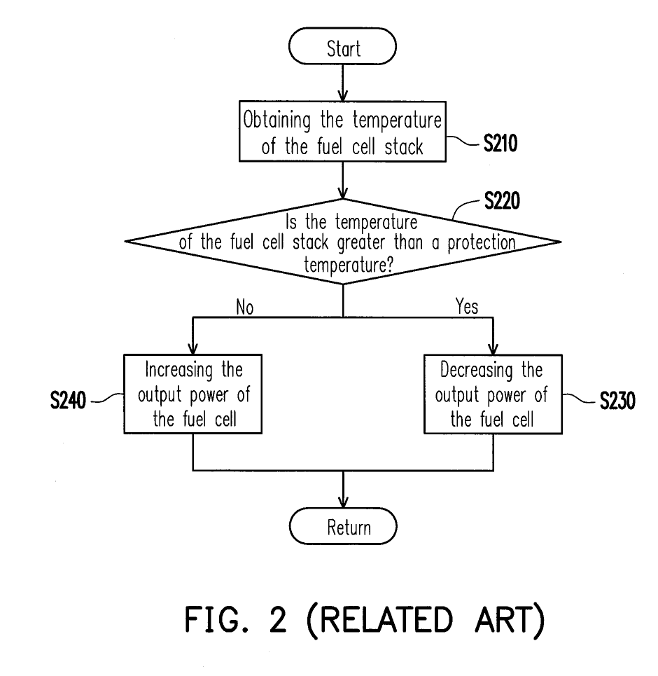

In an embodiment of the invention, the processor 350 increases or decreases the current heating amount E_{gen} by adjusting an operating point of the fuel cell system 300. In detail, when the fuel cell system 300 operates, an operating curve thereof is as shown in FIG. 1, and the processor 350 changes a position of the operating point on the operating curve by adjusting the output voltage or the output current of the converter 360.

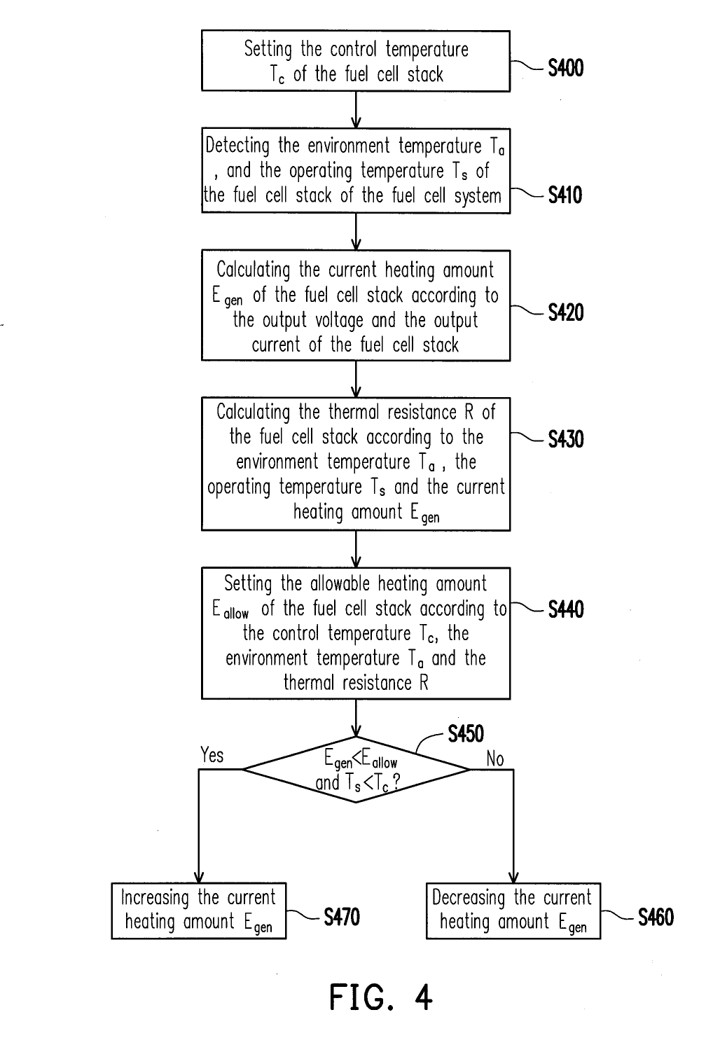

FIG. 4 is a flowchart illustrating a method for controlling a fuel cell system according to an embodiment of the invention. Referring to FIG. 4, in step S400, the control temperature T_{c} of the fuel cell stack 310 is set according to a characteristic of the fuel cell system 300. In step S410, the first temperature sensor 320 is used to detect the environment temperature Tₐ, and the second temperature sensor 330 is used to detect the operating temperature Tₛ of the fuel cell stack 310. In step S420, the processor 350 calculates the current heating amount E_{gen} of the fuel cell stack 310 according to the output voltage Vₛ and the output current Iₛ of the fuel cell stack 310. In step S430, the processor 350 calculates the thermal resistance R of the fuel cell stack 310 according to the environment temperature Tₐ, the operating temperature Tₛ, and the current heating amount E_{gen}. In step S440, the processor 350 sets the allowable heating amount E_{allow} of the fuel cell stack 310 according to the control temperature T_{c}, the environment temperature Tₛ, and the thermal resistance R. In step S450, the processor 350 determines whether the current heating amount E_{gen} is less than the allowable heating amount E_{allow} and the operating temperature Tₛ is less than the control temperature T_{c}. If the current heating amount E_{gen} is greater than the allowable heating amount E_{allow} or the operating temperature Tₛ is greater than the control temperature T_{c}, the current heating amount E_{gen} is decreased (step S460). If the current heating amount E_{gen} is less than the allowable heating amount E_{allow} and the operating temperature Tₛ is less than the control temperature T_{c}, the current heating amount E_{gen} is increased (step S470). It should be noticed that in an embodiment of the invention, the fuel cell system 300 executes the above steps (steps S410-S470) repeatedly in a predetermined interval (for example, 10 seconds).

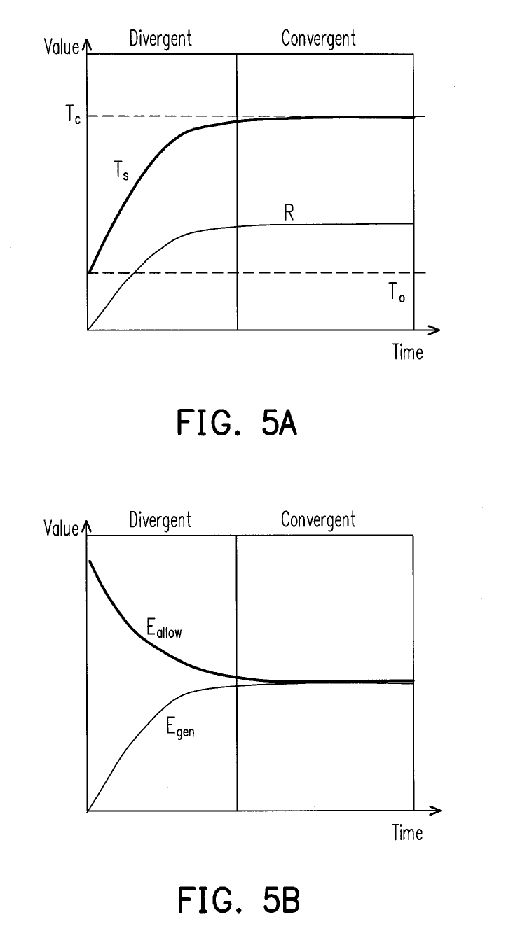

FIG. 5A is a graphical illustration of operating temperature Tₛ of the fuel cell stack versus time and thermal resistance R of the fuel cell stack versus time after the fuel cell system 300 is operated according to an embodiment of the invention. FIG. 5B is a graphical illustration of allowable heating amount E_{allow} of the fuel cell stack versus time and the current heating amount E_{gen} of the fuel cell stack versus time after the fuel cell system300 is operated according to an embodiment of the invention. Referring to FIG. 5A and FIG. 5B, after the fuel cell system 300 is operated, the operating temperature Tₛ of the fuel cell stack 310 is gradually increased from the environment temperature Tₐ to the control temperature T_{c}. Before the operating temperature Tₛ is increased, the thermal resistance R is relatively small, so that the allowable heating amount E_{allow} is relatively great. Then, as the operating temperature Tₛ is increased, the thermal resistance R is also increased, and the allowable heating amount E_{allow} is accordingly decreased. Finally, the current heating amount E_{gen} is equal to the allowable heating amount E_{allow}, and the operating temperature Tₛ is equal to the control temperature T_{c} to achieve a thermal balance state of the system.

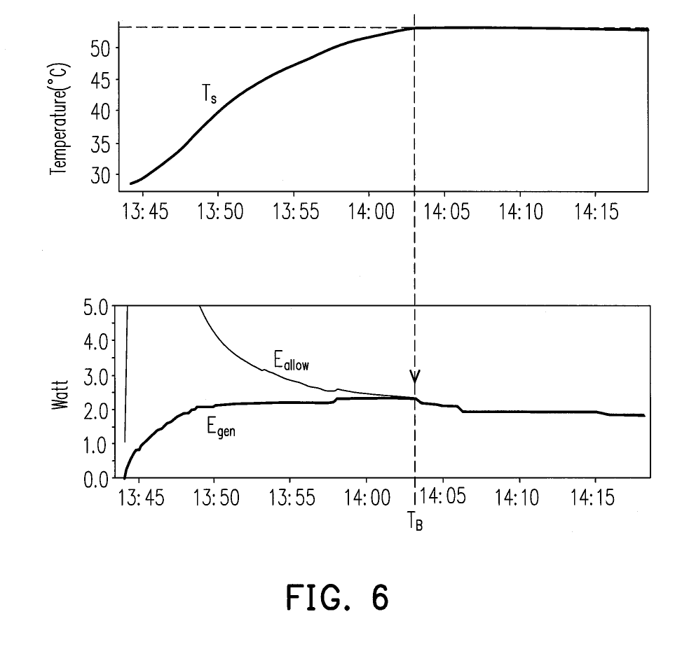

FIG. 6 is a graphical illustration of operating temperature Tₛ versus time, the allowable heating amount E_{allow} versus time, and the current heating amount E_{gen} versus time, which are obtained through an actual test of the fuel cell system 300 according to an embodiment of the invention. The test conditions are as follows. The environment temperature Tₐ is 27±1° C., the control temperature T_{c} is set to 53° C., and the test is performed under a natural convection condition without using a cooling device (for example, a fan). A test record is as that shown in FIG. 6, where before the control temperature 53° C. is reached, the allowable heating amount D_{allow} is divergent. Namely, as the operating temperature Tₛ of the fuel cell stack is gradually increased, the allowable heating amount E_{allow} is gradually decreased to approach the current heating amount E_{gen}. After a time point T_{B}, the operating temperature Tₛ is stabilized within the control temperature 53° C. Therefore, according to the aforementioned embodiments of the invention, the temperature of the fuel cell could be effectively controlled in a stable state.

In summary, in at least one of the aforementioned embodiments of the invention, the processor of the fuel cell system sets the allowable heating amount of the fuel cell stack according to the difference between the environment temperature and the temperature of the fuel cell stack to safely and effectively control the temperature of the fuel cell stack without a cooling device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for controlling a fuel cell system, the fuel cell system having a fuel cell stack, and the method comprising:
setting a control temperature of the fuel cell stack;
detecting an environment temperature of the fuel cell system and an operating temperature of the fuel cell stack;
calculating a current heating amount of the fuel cell stack according to an output voltage and an output current of the fuel cell stack;
calculating a thermal resistance according to the environment temperature, the operating temperature, and the current heating amount;
setting an allowable heating amount of the fuel cell stack according to the control temperature, the environment temperature, and the thermal resistance;
increasing the current heating amount when the current heating amount is less than the allowable heating amount and the operating temperature is less than the control temperature; and
decreasing the current heating amount when the current heating amount is greater than the allowable heating amount or the operating temperature is greater than the control temperature.

2. The method for controlling the fuel cell system as claimed in claim 1, wherein the environment temperature is Tₐ, the operating temperature is Tₛ, the control temperature is T_{c}, the current heating amount is E_{gen}, and the thermal resistance is R,
$$R = \frac{( {T}_{s} - {T}_{a} )}{{E}_{gen}} ,$$
and the allowable heating amount is equal to
$$\frac{( {T}_{c} - {T}_{a} )}{R} .$$

3. The method for controlling the fuel cell system as claimed in claim 1, wherein the current heating amount is increased or decreased by adjusting the output voltage or the output current of the fuel cell stack.

4. The method for controlling the fuel cell system as claimed in claim 1, wherein the fuel cell stack is a proton exchange membrane fuel cell (PEMFC) stack.

5. A fuel cell system, comprising:
a fuel cell stack, for carrying out a chemical reaction to produce electric energy;
a first temperature sensor, for detecting an operating temperature of the fuel cell stack;
a second temperature sensor, for detecting an environment temperature;
a voltage current detection unit, for detecting an output voltage and an output current of the fuel cell stack; and
a processor, electrically connected to the first temperature sensor, the second temperature sensor, and the voltage current detection unit, wherein the processor calculates a current heating amount of the fuel cell stack according to the output voltage and the output current of the fuel cell stack, the processor calculates a thermal resistance of the fuel cell stack according to the environment temperature, the operating temperature, and the current heating amount, and the processor sets an allowable heating amount of the fuel cell stack according to a control temperature, the environment temperature, and the thermal resistance, and the processor adjusts the current heating amount according to the current heating amount, the allowable heating amount, the operating temperature, and the control temperature.

6. The fuel cell system as claimed in claim 5, further comprising a converter, electrically connected to the fuel cell stack and the processor, for converting the output voltage or the output current of the fuel cell stack.

7. The fuel cell system as claimed in claim 6, wherein the processor controls the converter to adjust the current heating amount.

8. The fuel cell system as claimed in claim 5, wherein the environment temperature is Tₐ, the operating temperature is Tₛ, the control temperature is T_{c}, the current heating amount is E_{gen}, and the thermal resistance is R,
$$R = \frac{( {T}_{s} - {T}_{a} )}{{E}_{gen}} ,$$
and the allowable heating amount is equal to
$$\frac{( {T}_{c} - {T}_{a} )}{R} .$$

9. The fuel cell system as claimed in claim 5, wherein the fuel cell stack is a proton exchange membrane fuel cell (PEMFC) stack.
